(19) United States
(12) Patent Application Publication
(10) Pub. No.: US 2023/0400577 A1
(43) Pub. Date: Dec. 14, 2023

(54) LIDAR DEVICE AND RANGING ADJUSTMENT METHOD OF THE SAME

(71) Applicant: SUTENG INNOVATION TECHNOLOGY CO., LTD., Shenzhen (CN)

(72) Inventor: Changsheng GONG, Shenzhen (CN)

(73) Assignee: SUTENG INNOVATION TECHNOLOGY CO., LTD., Shenzhen (CN)

(21) Appl. No.: 18/207,735

(22) Filed: Jun. 9, 2023

(30) Foreign Application Priority Data
Jun. 14, 2022 (CN) 202210668020.0

(51) Int. Cl. G01S 17/32; G01S 7/4861; G01S 7/4865; G01S 17/89

(52) U.S. Cl. CPC G01S 17/32; G01S 7/4861; G01S 7/4865; G01S 17/89

(57) ABSTRACT

The present disclosure provides a LiDAR device and a ranging adjustment method of the same. The ranging adjustment method includes: obtaining position information of a receiving unit corresponding to a to-be-scanned emission unit, and querying a table to obtain an attenuation coefficient matching the receiving unit; calculating a number of continuous laser beam emissions or an emission power of the emission unit corresponding to the receiving unit in a frame of a scanning image based on the attenuation coefficient; driving the emission unit to emit a laser beam based on the number of emissions or the emission power, simultaneously driving the receiving unit corresponding to the emission unit to receive a corresponding echo laser beam signal, and superimposing the echo laser beam signal into corresponding histogram data; and determining distance information of a to-be-detected object based on the histogram data.

### CROSS-REFERENCE TO RELATED APPLICATION

The present application claims the benefit of priority to Chinese Patent Application No. 202210668020.0, filed on Jun. 14, 2022, which is hereby incorporated by reference in its entirety.

### TECHNICAL FIELD

The present disclosure pertains to the technical field of LiDAR, and in particular, to a LiDAR device and a ranging adjustment method of the same.

### BACKGROUND

With continuous development of fields of artificial intelligence and autonomous driving, increasingly high requirements are imposed on detection accuracy of LiDAR.

In the LiDAR, due to a characteristic of a lens, illuminance of an edge field of view in an illuminated field of view is lower than that of a central field of view. In addition, the larger the detection angle of view, the lower the illuminance of the edge field of view. In addition, to improve imaging quality in the edge field of view, vignetting needs to be set for light in the edge field of view, which aggravates a reduction in illuminance of the edge field of view, thereby affecting accuracy of ranging.

### SUMMARY

The present disclosure aims to provide a ranging adjustment method of a LiDAR device, to resolve a problem that ranging accuracy is affected because illuminance of a conventional LiDAR device in a field of view is non-uniform.

A first aspect of embodiments of the present disclosure provides a ranging adjustment method of a LiDAR device, where the LiDAR device includes a laser beam emission module and a laser beam receiving module, and the laser beam receiving module includes receiving units arranged into an array; and the ranging adjustment method of a LiDAR device includes the following steps:
obtaining position information of a receiving unit corresponding to a to-be-scanned emission unit, and querying a table to obtain an attenuation coefficient matching the receiving unit;
calculating the number of continuous laser beam emissions and/or emission power of the emission unit corresponding to the receiving unit in a frame of a scanning image based on the attenuation coefficient;
driving the emission unit to emit a laser beam based on the number of emissions and/or the emission power, simultaneously driving the receiving unit corresponding to the emission unit to receive a corresponding echo laser beam signal, and superimposing the echo laser beam signal into corresponding histogram data; and determining distance information of a to-be-detected object based on the histogram data.

In some embodiments, before obtaining position information of a receiving unit corresponding to a to-be-scanned emission unit, and querying a table to obtain an attenuation coefficient matching the receiving unit, the ranging adjustment method of a LiDAR device further includes:
obtaining a correspondence between the to-be-scanned emission unit and the receiving unit; and
querying the table based on the correspondence to obtain the attenuation coefficient matching the receiving unit, where when the correspondence between the to-be-scanned emission unit and the receiving unit is a one-to-one correspondence, the attenuation coefficient of the receiving unit is an attenuation coefficient of the receiving unit corresponding to the to-be-scanned emission unit; or when the correspondence between the to-be-scanned emission unit and the receiving unit is a one-to-multiple or multiple-to-multiple correspondence, the attenuation coefficient of the receiving unit is a minimum attenuation coefficient of multiple receiving units corresponding to the to-be-scanned emission unit.

In some embodiments, a calculation formula of the number of superimpositions of the histogram data corresponding to the receiving unit is as follows:

$$num 2 = {( \frac{coe 1}{coe 2} )}^{2} * num 1 ;$$

where coe1 is an attenuation coefficient of a reference receiving unit, coe2 is an attenuation coefficient of the receiving unit corresponding to the to-be-scanned emission unit, num1 is the number of superimpositions of histogram data corresponding to the reference receiving unit, and num2 is the number of superimpositions of histogram data corresponding to the receiving unit corresponding to the to-be-scanned emission unit.

In some embodiments, steps of driving the corresponding receiving unit to receive a corresponding echo laser beam signal, and superimposing the echo laser beam signal into corresponding histogram data include: obtaining an attenuation coefficient of the receiving unit corresponding to the emission unit;
calculating the number of echo superimpositions of the receiving unit based on the attenuation coefficient of the receiving unit; and performing corresponding histogram data superimposition on the echo laser beam signal based on the number of echo superimpositions to form the corresponding histogram data.

In some embodiments, determining distance information of a to-be-detected object based on the histogram data includes:
performing any calculation policy of constant-ratio timing calculation, peak value calculation and half-value calculation on the histogram data to determine a time difference between laser beam emission and reception; and
determining the distance information of the to-be-detected object based on the time difference.

In some embodiments, the ranging adjustment method of a LiDAR device further includes:
obtaining a peak value of the histogram data:
   determining whether the peak value of the histogram data is less than a preset threshold; and
   when the peak value of the histogram data is less than the preset threshold, adjusting the number of emissions and/or emission power for a next emission.

A second aspect of the embodiments of the present disclosure provides a LiDAR device, including a laser beam emission module, a laser beam receiving module, and a control circuit respectively connected to the laser beam emission module and the laser beam receiving module, where the control circuit includes a drive and conversion circuit, a memory, a processor, and a computer program stored in the memory and capable of running on the processor, where when executing the computer program, the processor correspondingly drives the drive and conversion circuit to implement steps of the ranging adjustment method of a LiDAR device described above; and the laser beam receiving module include receiving units arranged into an array.

In some embodiments, the emission unit includes a laser, and the laser beam emission module also includes an emission lens disposed corresponding to the laser; and the receiving unit includes a photoelectric converter, and the laser beam receiving module further includes at least one receiving lens disposed corresponding to photoelectric converters arranged into an array.

In some embodiments, the drive and conversion circuit includes: a laser beam drive circuit respectively connected to the processor and the laser beam emission module, where the laser beam drive circuit is correspondingly turned on or off based on a control signal output by the processor, and adjusts the number of laser beam emissions and/or emission power of the emission unit in a frame of a scanning image; and a signal conversion circuit respectively connected to the laser beam receiving module and the processor, where the signal conversion circuit is configured to: convert a current signal converted and output by the receiving unit into a corresponding echo pulse signal, and output the echo pulse signal to the processor.

In some embodiments, the photoelectric converter includes a photoelectric conversion diode.

The embodiments of the present disclosure have beneficial effects. In the foregoing ranging adjustment method of a LiDAR device, the position information of the receiving unit corresponding to the to-be-scanned emission unit is determined, and a table is queried based on the position information to determine the attenuation coefficient of the receiving unit; the number of required laser beam emissions and/or the emission power is calculated based on the attenuation coefficient, and laser beam emission and reception work is performed based on the number of laser beam emissions and/or the emission power; and the corresponding histogram data are obtained based on the number of echo superimpositions of the corresponding histogram, the distance information of the to-be-detected object is determined based on the histogram data, and the number of laser beam emissions and/or the emission power of the emission unit corresponding to the receiving unit at the corresponding position is adjusted, so that ranging accuracy and a ranging capability are improved and the entire receiving array has the same ranging capability, thereby improving ranging uniformity.

### BRIEF DESCRIPTION OF DRAWINGS

FIG. 1 is a first schematic structural diagram of a LiDAR device according to an embodiment of the present disclosure;

FIG. 2 is a schematic histogram of a ranging adjustment method of a LiDAR device according to an embodiment of the present disclosure;

FIG. 3 is a first schematic flowchart of a ranging adjustment method of a LiDAR device according to an embodiment of the present disclosure;

FIG. 4 is a schematic diagram of an attenuation coefficient of a receiving array in a LiDAR device according to an embodiment of the present disclosure:

FIG. 5 is a first flowchart of step S30 of the ranging adjustment method of a LiDAR device shown in FIG. 3;

FIG. 6 is a first flowchart of step S40 of the ranging adjustment method of a LiDAR device shown in FIG. 3;

FIG. 7 is a second schematic flowchart of a ranging adjustment method of a LiDAR device according to an embodiment of the present disclosure;

FIG. 8 is a schematic diagram of an echo waveform in a ranging adjustment method of a LiDAR device according to an embodiment of the present disclosure;

FIG. 9 is a second schematic structural diagram of a LiDAR device according to an embodiment of the present disclosure; and

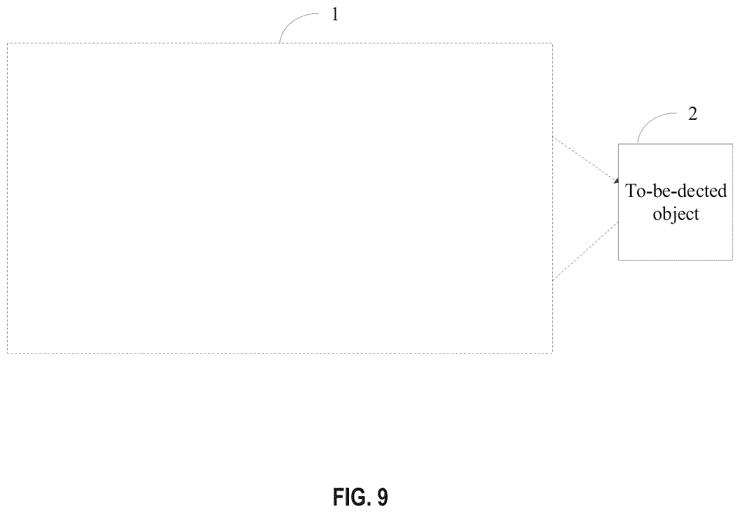

FIG. 10 is a third schematic structural diagram of a LiDAR device according to an embodiment of the present disclosure.

### DETAILED DESCRIPTION

To more clearly describe technical solutions and beneficial effects of the present disclosure, the following further describes in detail with reference to the accompanying drawings and embodiments. It should be understood that the embodiments described herein are only used to explain the present disclosure, and are not intended to limit the present disclosure.

In addition, the terms such as “first” and “second” are merely intended for the purpose of description, and shall not be understood as an indication or implication of relative importance or implicit indication of a quantity of indicated technical features. Therefore, a feature with a determiner such as “first” or “second” may expressly or implicitly include one or more features. In the description of the present disclosure, “a plurality of” means two or more, unless otherwise specifically defined.

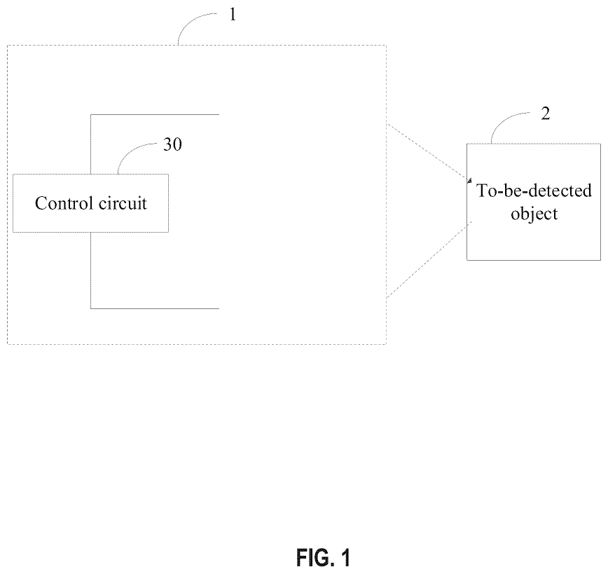

A first aspect of the embodiments of the present disclosure proposes a ranging adjustment method of a LiDAR device 1. As shown in FIG. 1, the LiDAR device 1 includes a laser beam emission module 10 and a laser beam receiving module 20. The laser beam emission module 10 and the laser beam receiving module 20 are driven by a corresponding control circuit 30 to perform laser beam emission and reception work. The laser beam emission module 10 includes a single emission unit or m1 (rows)×n1 (columns) emission units arranged into an array, and the laser beam receiving module 20 includes m2 (rows)×n2 (columns) receiving units arranged into an array, where m1 and n1 are both greater than or equal to 1, m2 and n2 are both greater than or equal to 1, m1 and m2 can be equal or unequal, and likewise, n1 and n2 can be equal or unequal. That is, in some embodiments, the number of rows and the number of columns of the emission array can be in a one-to-one correspondence with those of the receiving array. In some embodiments, the emission array and the receiving array can have unequal numbers of rows and equal numbers of columns. In some embodiments, the emission array and the receiving array can have equal numbers of rows and unequal numbers of columns. This application imposes no limitation on specific structures of the emission array and the receiving array.

It can be understood that this application also imposes no limitation on the scanning form of the LiDAR The LiDAR can include scanning members such as a rotating mirror or a galvanometer, and the LiDAR can also be a mechanical rotary LiDAR, that is, a turntable drives the emission array and the receiving array to rotate and scan. In some embodiments, the LiDAR in this application may also be pure solid-state LiDAR. A specific type of LiDAR is not limited in this application.

That is, the LiDAR device 1 is a LiDAR device 1 including at least one row or column of receiving units, for example, one emission unit and one array receiving unit. One emission unit emits the corresponding number of laser beams, and multiple receiving units receive the same number of echo laser beam signals simultaneously or in a preset timing sequence. In some embodiments, the LiDAR device 1 includes an array emission unit and an array receiving unit, and emission units and receiving units are in a one-to-one, one-to-multiple, or multiple-to-multiple correspondence to perform laser beam emission and receiving work. Therefore, a specific correspondence between the emission unit and the receiving unit is set based on a structure and a requirement of the LiDAR device 1, and is not specifically limited herein. For example, an array LiDAR device uses an array emission device and an array receiving device, and there is no moving component inside the LiDAR, which is currently an effective design structure for improving reliability of the LiDAR device 1.

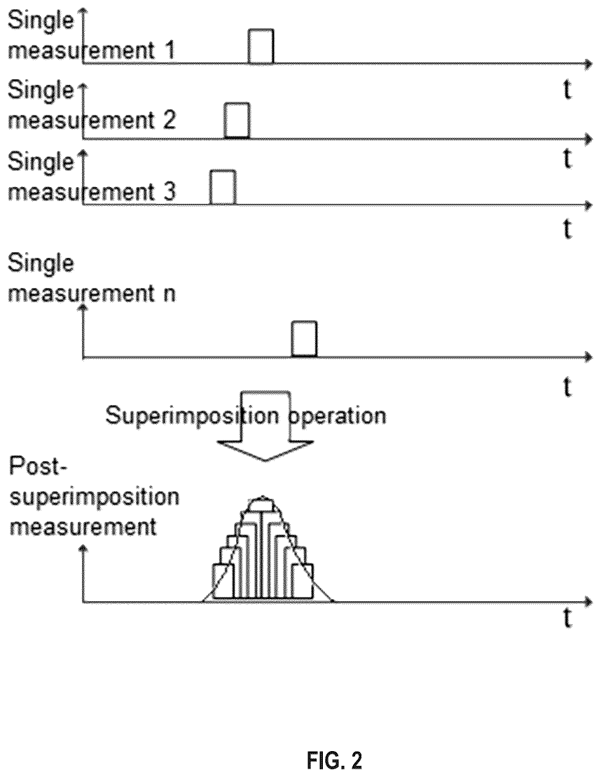

The laser beam emission module 10 also includes an emission lens disposed in the emission unit. The emission lens includes one or more lenses. The laser beam receiving module 20 also includes a receiving lens disposed in an array structure. The receiving lens includes one or more lenses, and the laser beam emission module 10 is driven by the control circuit 30 to emit a laser beam of corresponding power and/or the number of laser beams to the to-be-detected object 2. The laser beam is reflected by the to-be-detected object 2 back to the laser beam receiving module 20, and the receiving unit receives the corresponding echo laser beam signal through the receiving lens. The control circuit 30 converts the echo laser beam signal into a corresponding echo pulse signal, and superimposes the echo pulse signal into the corresponding histogram data. Herein, as shown in FIG. 2, the histogram data refers to histogram data with changing amplitude in a time sequence that is formed by superimposing multiple converted and output echo pulse signals in a time sequence.

Taking the array LiDAR device as an example, an emission portion is an array structure formed by multiple emission units, and a receiving portion is an array structure formed by multiple receiving units. The emission lens disposed in the array structure includes one or more lenses, and the receiving lens includes one or more lenses.

In different fields of view, alight spot experiences inconsistent divergence. Generally, divergence of the light spot in an edge field of view in the lens is more severe than that in the middle field of view in the lens, and as a result, illuminance in the edge field of view in the field of view is lower than that in a central field of view. Under the same conditions of emission power and performance of a receiving device, the more divergent the light spot, the lower the illuminance and the weaker the final ranging capability; or the more concentrated the light spot, the higher the illuminance and the stronger the ranging capability. With optical lenses at different positions, different receiving units have inconsistent ranging capabilities.

Receiving units with optical lens at different positions have different attenuation coefficients, and therefore, have greatly different ranging capabilities, which affects uniformity of the ranging capabilities of the receiving array.

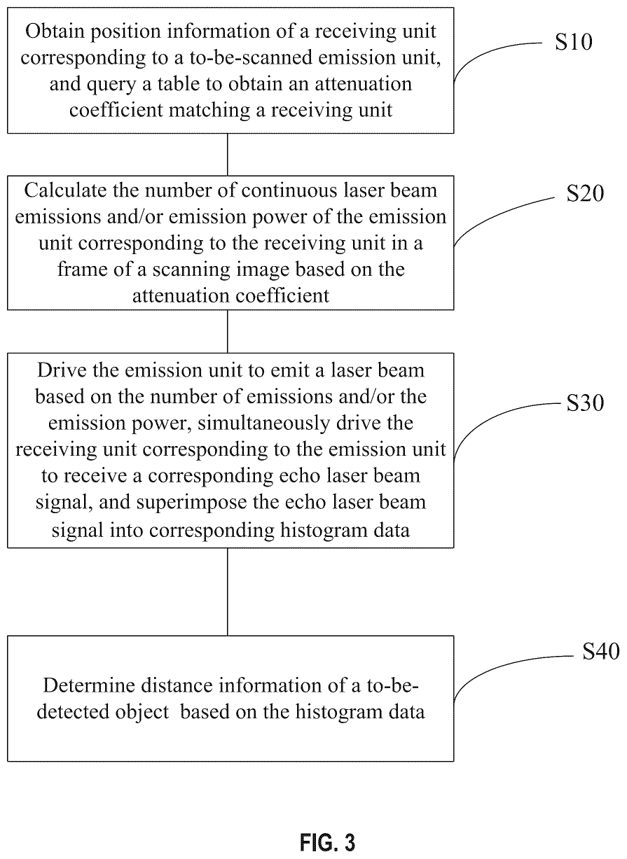

In order to balance and uniformize the ranging capabilities of the receiving units at different receiving lens positions and improve ranging accuracy, a ranging adjustment method is proposed. As shown in FIG. 3, the ranging adjustment method includes the following steps.

Step S10: Obtain position information of a receiving unit corresponding to a to-be-scanned emission unit, and query a table to obtain an attenuation coefficient matching a receiving unit.

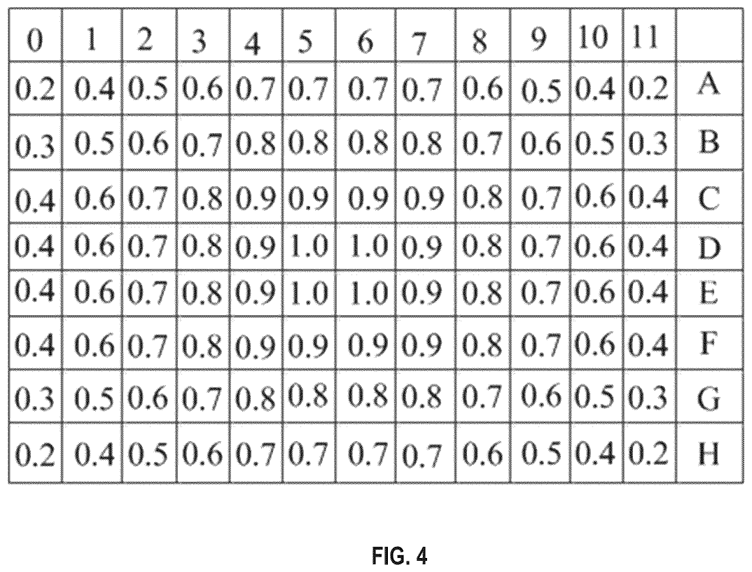

In some embodiments, the position information refers to position information of the receiving unit in the receiving array. As shown in FIG. 4, each receiving unit is in corresponding row and column positions, the receiving units corresponding to positions have different attenuation coefficients, and the corresponding position information and the attenuation coefficients have a mapping relationship to form an attenuation coefficient table stored in the control circuit 30. When the control circuit 30 drives the corresponding emission units or receiving units one by one or simultaneously based on an emission and reception manner, for example, a manner of performing emission and reception successively or simultaneously. The position information of one or more receiving units corresponding to the to-be-scanned emission unit is obtained in advance, and the matched attenuation coefficient is found by querying the attenuation coefficient table.

Herein, the attenuation coefficient refers to a ratio of the number of incident photons to the number of received photons. For example, when 100 photons are incident and 80 photons are received by the receiving unit, it indicates that the attenuation coefficient is 80%, that is, 0.8. When the attenuation coefficient is 1, it indicates that the number of photons incident on the receiving lens is equal to the number of received photons, and the number of photons is not attenuated, thereby obtaining the maximum attenuation coefficient. The attenuation coefficient is related to the position of the receiving unit relative to the receiving lens and the material of the receiving lens.

Herein, an attenuation coefficient of each receiving unit can be calculated and calibrated theoretically based on a position relationship and an angle, or can be calibrated based on actual optical detection. That is, the attenuation coefficient of each receiving unit is calculated theoretically based on a divergence angle of an outgoing light spot of the corresponding emission unit and/or is calibrated and determined via optical detection. After the attenuation coefficient of each receiving unit is determined, the attenuation coefficient and the position relationship of each receiving unit form mapping and are stored to form the attenuation coefficient table.

Step S20: Calculate the number of continuous laser beam emissions and/or emission power of the emission unit corresponding to the receiving unit in a frame of a scanning image based on the attenuation coefficient.

Step S30: Drive the emission unit to emit a laser beam based on the number of emissions and/or the emission power, simultaneously drive the receiving unit corresponding to the emission unit to receive a corresponding echo laser beam signal, and superimpose the echo laser beam signal into corresponding histogram data.

In some embodiments, in order to improve the ranging accuracy and the ranging capability, for a receiving unit with a small attenuation coefficient (that is, a low ranging capability), an overall ranging capability of a LiDAR system can be improved by increasing the laser beam emission power and/or the number of laser beam emissions of the emission unit. Herein, the number of laser beam emissions of each laser beam emission unit in the frame of scanning image is increased, that is, the number of echo superimpositions of the histogram data is increased, to improve a signal-to-noise ratio of a signal and improve the ranging capability. The emission power is increased to increase intensity of the echo signal, thereby improving the ranging capability. One of the two methods can be selected, or the two methods can be combined. For example, adjustment can be performed separately in the time sequence. For example, if the emission power is determined based on a power consumption requirement setting, the number of emissions is increased priorly, or based on a device limitation, if the emission frequency is the maximum, the emission power is increased priorly. In some embodiments, the number of emissions and/or the emission power may be set with reference to a power consumption requirement or a limitation on detection frequency.

In addition, in order to match the attenuation coefficients with different receiving units, the number of laser beam emissions and/or the emission power is determined in a corresponding calculation method. Herein, the attenuation coefficient is negatively correlated with the number of laser beam emissions, that is, the larger the attenuation coefficient of the receiving unit, the smaller the number of laser beam emissions required for the corresponding emission unit; or the smaller the attenuation coefficient of the receiving unit, the larger the number of laser beam emissions required for the corresponding emission unit.

In addition, the attenuation coefficient is negatively correlated with the emission power, that is, the larger the attenuation coefficient of the receiving unit, the smaller the emission power required for the corresponding emission unit; or the smaller the attenuation coefficient of the receiving unit, the larger the emission power required for the corresponding emission unit.

After the number of laser beam emissions and/or the emission power of the to-be-scanned emission unit is determined, the control circuit 30 drives the corresponding to-be-scanned emission unit and the corresponding receiving unit to perform continuous laser beam emission and reception work multiple times. In addition, the control circuit 30 forms the histogram data based on multiple echo pulse signals in a changing time sequence that are converted by the receiving unit.

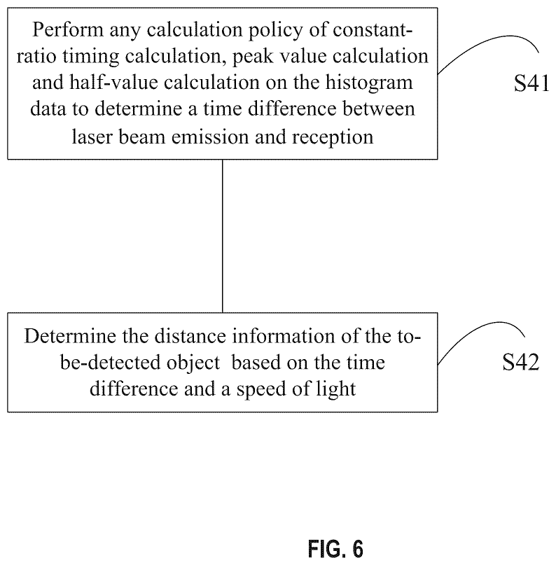

Step S40: Determine distance information of a to-be-detected object 2 based on the histogram data; and after the histogram data are determined, the control circuit 30 determines the distance information of the to-be-detected object 2 based on amplitude of the histogram data and the corresponding calculation policy, where the distance information can be determined in a corresponding calculation method. As shown in FIG. 6, in some embodiments, determining the distance information of the to-be-detected object 2 based on the histogram data includes:

Step S41: Perform any calculation policy of constant-ratio timing calculation, peak value calculation and half-value calculation on the histogram data to determine a time difference between laser beam emission and reception. Step S42: Determine the distance information of the to-be-detected object 2 based on the time difference and a speed of light.

Further, based on different emission and receiving correspondences between the emission unit and the receiving unit, the attenuation coefficients for determining the final number of emissions are different. In some embodiments, before obtaining position information of a receiving unit corresponding to a to-be-scanned emission unit, and querying a table to obtain an attenuation coefficient matching the receiving unit, the ranging adjustment method of a LiDAR device further includes:
obtaining a correspondence between the to-be-scanned emission unit and the receiving unit; and querying the table based on the correspondence to obtain the attenuation coefficient matching the receiving unit, where when the correspondence between the to-be-scanned emission unit and the receiving unit is a one-to-one correspondence, the attenuation coefficient of the receiving unit is an attenuation coefficient of the receiving unit corresponding to the to-be-scanned emission unit; or when the correspondence between the to-be-scanned emission unit and the receiving unit is a one-to-multiple or multiple-to-multiple correspondence, the attenuation coefficient of the receiving unit is a minimum attenuation coefficient of multiple receiving units corresponding to the to-be-scanned emission unit.

In some embodiments, before scanning, the correspondence between the emission unit and the receiving unit in the LiDAR device 1 is first obtained, and then the corresponding attenuation coefficient and the number of laser beam emissions and/or the emission power corresponding to the attenuation coefficient are determined and selected.

When the emission unit and the receiving unit are disposed one-to-one to perform emission and reception, the attenuation coefficient of the to-be-scanned receiving unit is used to calculate the attenuation coefficient corresponding to the number of laser beam emissions and/or the emission power, and the attenuation coefficient of the receiving unit is used to determine the number of laser beam emissions and/or the emission power. The control circuit 30 performs corresponding histogram data superimposition on the echo laser beam signal based on the corresponding number of echo superimpositions, thereby forming the histogram data. In addition, the histogram data are used to determine the distance information of the to-be-detected object 2, where the number of laser beam emissions is greater than or equal to the number of echo superimpositions.

In addition, when the emission units and the receiving units are disposed one-to-multiple or multiple-to-multiple, in order to improve the overall uniformity of ranging and ensure that multiple receiving units all can receive echo laser beam signals corresponding to the number of emissions and/or the emission power, position information of multiple receiving units corresponding to the to-be-scanned emission unit is obtained, and the table is queried to obtain the attenuation coefficients matching the multiple receiving units. In addition, the number of laser beam emissions of the corresponding emission unit is determined via the minimum attenuation coefficient, to ensure that the multiple receiving units corresponding to the emission unit can receive multiple echo laser beam signals corresponding to a laser beam emitted by the emission unit. For example, attenuation coefficients of four receiving units corresponding to the to-be-scanned emission unit are 0.6, 0.6, 0.4, and 0.2 separately. The attenuation coefficient of 0.2 is used as a target attenuation coefficient, and the number of laser beam emissions and/or the emission power of the emission unit is calculated via the target attenuation coefficient to determine the number of laser beam emissions and/or the emission power. The emission unit is driven to superimpose the echo laser beam signal based on the determined number of laser beam emissions and/or emission power, to generate the corresponding histogram data. Herein, the number of superimpositions of echo signals of each of the multiple receiving units may be the same as the number of emissions of the corresponding emission unit.

In some embodiments, after the number of laser beam emissions and/or the emission power is determined, in order to obtain matched amplitude and the number of times of the histogram data of the corresponding receiving unit, it is necessary to obtain the number of echo superimpositions of each corresponding receiving unit. In some embodiments, a formula for calculating the number of superimpositions of the corresponding histogram data of the receiving unit is as follows:

$$num 2 = {( \frac{coe 1}{coe 2} )}^{2} * num 1 ;$$

where coe1 is an attenuation coefficient of a reference receiving unit, coe2 is an attenuation coefficient of the receiving unit corresponding to the to-be-scanned emission unit, num1 is the number of superimpositions of histogram data corresponding to the reference receiving unit, and num2 is the number of superimpositions of histogram data corresponding to the receiving unit corresponding to the to-be-scanned emission unit. The number of echo superimpositions of the histogram data corresponding to each of the multiple receiving units can be calculated based on the formula. The echo laser beam signal is superimposed based on the number of echo superimpositions corresponding to each receiving unit to obtain corresponding histogram data.

Herein, a reference receiving unit may be any receiving unit in the receiving array with an attenuation coefficient and the number of emissions and/or the emission power of the emission unit corresponding to the attenuation coefficient being known. Generally, a receiving unit having the maximum attenuation coefficient in the middle of the receiving array can be selected as the reference receiving unit. Based on the number of laser beam emissions of the emission unit corresponding to the reference receiving unit, the number of laser beam emissions of the emission unit corresponding to receiving units at other positions and the number of echo superimpositions of the corresponding histogram data are determined via a calculation formula, and the number of laser beam emissions is determined based on the number of echo superimpositions. Herein, the number of laser beam emissions is greater than or equal to the number of echo superimpositions of the histogram data, each time the emission unit performs emission, the receiving unit performs receiving correspondingly. The control circuit 30 superimposes the histogram data based on the calculated number of echo superimpositions.

For example, the calculated number of echo superimpositions is 50, the determined number of emissions is 60, the emission unit emits corresponding laser beam signals 60 times, and the control circuit 30 performs histogram data superimposition on first 50 echo laser beam signals to form the corresponding histogram data, thereby further improving the uniformity of ranging.

The reference receiving unit can be selected correspondingly. In some embodiments, based on a divergence characteristic of a light spot of the receiving unit of the array structure, one or more receiving units at the center of the receiving units arranged into the array are selected as the reference receiving unit. For example, four receiving units at the center of the receiving units of the array structure shown in FIG. 4 have the maximum ranging capability and a corresponding attenuation coefficient of 1, that is, the maximum attenuation coefficient. A receiving unit at an edge position have a corresponding attenuation coefficient between 0.2 and 0.7.

When the emission unit and the receiving unit are disposed one-to-one to perform emission and reception, taking a receiving unit with an attenuation coefficient of 0.2 as an example, assuming that the number of echo superimpositions at the center is 10, based on calculation, the corresponding number of echo superimpositions of the receiving unit with an attenuation coefficient of 0.2 is: 52×10=250, and the corresponding number of laser beam emissions is greater than or equal to 250. The number of laser beam emissions of an emission unit corresponding to the receiving unit with a small attenuation coefficient is increased, and the ranging accuracy is improved, thereby implementing overall ranging uniformity of the receiving array.

In addition, when the emission units and the receiving units are disposed one-to-multiple or multiple-to-multiple to perform emission and reception, in order to improve the overall uniformity of ranging, position information of multiple receiving units corresponding to the to-be-scanned emission unit is obtained, and the table is queried to obtain the attenuation coefficients matching the multiple receiving units. In addition, the number of echo superimpositions and the number of laser beam emissions of the corresponding emission unit are determined via the minimum attenuation coefficient, to ensure that the multiple receiving units corresponding to the emission unit can receive multiple echo laser beam signals corresponding to a laser beam emitted by the emission unit. For example, attenuation coefficients of four receiving units corresponding to the to-be-scanned emission unit are 0.6, 0.6, 0.4, and 0.2 separately, the attenuation coefficient of 0.2 is substituted for calculation, the corresponding number of echo superimpositions of the receiving unit with an attenuation coefficient of 0.2 is: 25×10=250, the corresponding number of laser beam emissions is greater than or equal to 250, and the four receiving units respectively receive more than 250 echo laser beam signals asynchronously or simultaneously.

Correspondingly, when the emission units and the receiving units are correspondingly disposed one-to-multiple or multiple-to-multiple, numbers of echo superimpositions required for the histogram data corresponding to the receiving units are different. For example, the multiple receiving units are A, B, C, and D respectively and have attenuation coefficients of 0.1, 0.2, 0.3, and 0.4, respectively, and the respective corresponding numbers of required echo superimpositions are 10, 20, 30 and 40, respectively. The number of laser beam emissions of the emission unit is greater than or equal to 40, assuming that the number of laser beam emissions is 40, the receiving unit D can receive 40 echo laser beam signals, the number of times is used as the number of echo superimpositions to obtain the required histogram data, and corresponding receiving units A, B, and C also receive 40 echo laser beam signals, but when the number of times is used as the number of echo superimpositions, the obtained histogram data does not meet a requirement for the respective preset amplitude and the number of times.

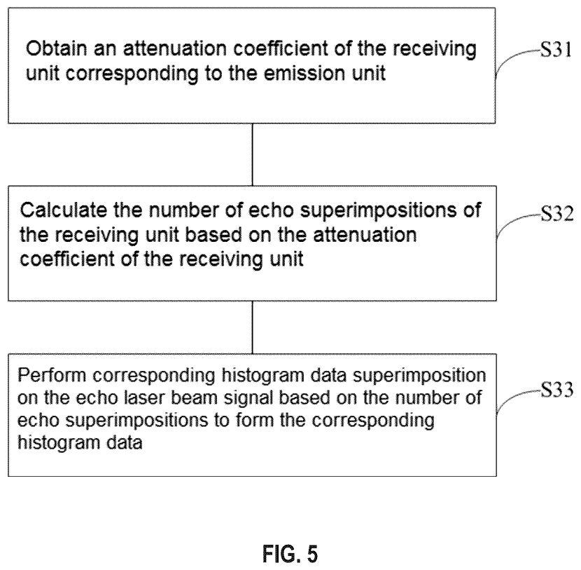

Therefore, when the emission units and the receiving units are correspondingly disposed one-to-one, one-to-multiple, or multiple-to-multiple to perform emission and reception, in order to obtain the histogram data of the receiving unit, it is necessary to obtain the number of echo superimpositions of the corresponding receiving unit. As shown in FIG. 5, steps of driving the corresponding receiving unit to receive a corresponding echo laser beam signal, and superimposing the echo laser beam signal into corresponding histogram data include:
Step S31: Obtain an attenuation coefficient of the receiving unit corresponding to the emission unit.
Step S32: Calculate the number of echo superimpositions of the receiving unit based on the attenuation coefficient of the receiving unit.
Step S33: Perform corresponding histogram data superimposition on the echo laser beam signal based on the number of echo superimpositions to form the corresponding histogram data.

In some embodiments, the number of laser beam emissions and/or the emission power is determined via the minimum attenuation coefficient of the multiple receiving units. The receiving units synchronously receive echo laser beam signals corresponding to the number of emissions and/or the emission power, and the control circuit 30 correspondingly superimposes the histogram data based on the number of echo superimpositions corresponding to the receiving units, thereby further improving the uniformity of ranging.

For example, the multiple receiving units are A, B, C, and D respectively and have attenuation coefficients of 0.1, 0.2, 0.3, and 0.4 respectively, and the respective corresponding numbers of required echo superimpositions are 10, 20, 30, and 40, respectively. The number of laser beam emissions of the emission unit is greater than or equal to 40, assuming that the number of laser beam emissions is 40, the receiving unit D can receive 40 echo laser beam signals, the number of times is used as the number of echo superimpositions to superimpose the histogram data, and corresponding receiving units A, B, and C separately superimpose the histogram data based on numbers of echo superimpositions, namely, 10, 20, and 30, to form histogram data corresponding to the respective preset amplitude and the number of times. The control circuit 30 determines the distance information corresponding to the receiving unit based on the determined respective histogram data.

The receiving unit converts the optical signal into an echo pulse signal corresponding to an electrical signal type, and the control circuit performs the corresponding histogram data superimposition on the multiple echo pulse signals obtained after receiving and conversion, to obtain histogram data with the corresponding peak value, timing, and area.

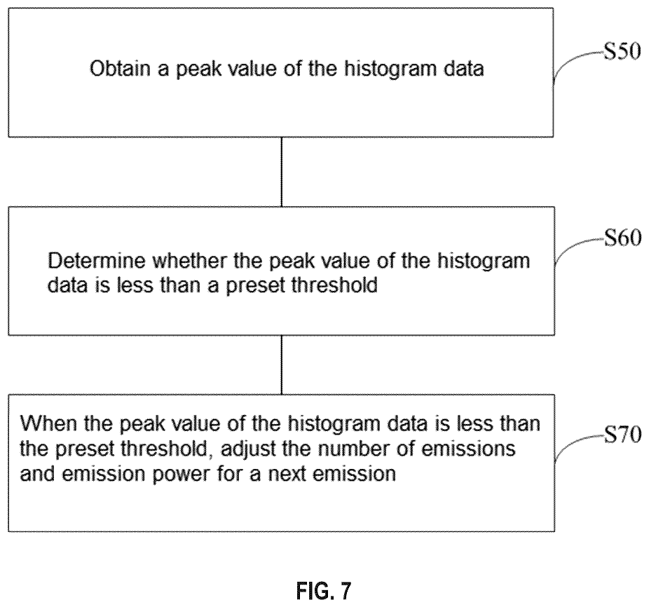

Further, in order to ensure that the histogram data obtained by superimposing the obtained echo data reaches a preset energy intensity range, as shown in FIG. 7, the ranging adjustment method of the LiDAR device also includes:
Step S50: Obtain a peak value of the histogram data.
Step S60: Determine whether the peak value of the histogram data is less than a preset threshold.
Step S70: When the peak value of the histogram data is less than the preset threshold, adjust the number of emissions and/or emission power for a next emission.

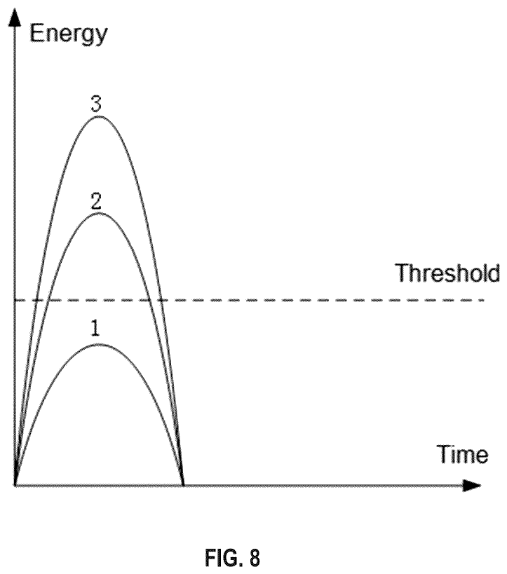

For example, FIG. 8 is a diagram of an echo waveform formed by a histogram. It can be seen that a peak value of an echo 1 is less than an energy threshold, it is necessary to increase the number of emissions and/or the emission power based on the echo energy before the next emission, an echo 2 and an echo 3 are greater than the energy threshold, and therefore, it is unnecessary to adjust the number of emissions and/or the emission power for the next time based on the echo.

It can be understood that when the determined peak value of the histogram data is less than the preset threshold, the number of emissions and/or the emission power are increased. In some embodiments, the next adjustment can be made based on a power consumption requirement or a setting requirement of the detection frequency. For example, if the power consumption has reached the set threshold, the number of emissions is adjusted priorly; or if the detection frequency has reached the preset threshold, the emission power is adjusted priorly. In some embodiments, the number of emissions and/or the emission power are adjusted based on preset adjustment timing.

In some embodiments, after the control circuit obtains the corresponding histogram data by performing data superimposition on the echo laser beam signal based on the determined number of echo superimpositions, a peak value of the histogram data is further compared and determined. When the peak value of the histogram data is excessively small, it is possible that the distance information of the to-be-detected object cannot be calculated via the obtained histogram data, resulting in failure of ranging. Therefore, in order to improve the accuracy of ranging, the control circuit adjusts the number of laser beam emissions and the emission power of the emission unit when scanning the emission unit and the corresponding receiving unit next time, for example, synchronously increases the number of emissions and the emission power, so that a peak value of the next superimposed histogram data reaches a threshold required for ranging, thereby improving the accuracy of ranging.

It should be understood that a sequence number of each step in the foregoing embodiments does not mean an execution sequence. An execution sequence of each process should be determined based on a function and internal logic of each process, and should not constitute any limitation to an implementation process of the embodiments of the present disclosure.

The embodiments of the present disclosure have beneficial effects as follows. In the foregoing ranging adjustment method of a LiDAR device 1, the position information of the receiving unit corresponding to the emission unit to perform scanning is determined, and a table is queried based on the position information to determine the attenuation coefficient of the receiving unit, the number of required laser beam emissions and/or the emission power is calculated based on the attenuation coefficient, and laser beam emission and reception work is performed based on the number of laser beam emissions and/or the emission power; and the corresponding histogram data is obtained based on the number of echo superimpositions of the corresponding histogram, the distance information of the to-be-detected object 2 is determined based on the histogram data, and the number of laser beam emissions and/or the emission power of the emission unit corresponding to the receiving unit at the corresponding position is adjusted, so that ranging accuracy and ranging capability are improved and the entire receiving array has the same ranging capability, thereby improving uniformity of ranging capabilities.

A second aspect of the embodiments of the present disclosure provides a LiDAR device 1. As shown in FIG. 7, the LiDAR device 1 includes a laser beam emission module 10, a laser beam receiving module 20, and a control circuit 30 respectively connected to the laser beam emission module 10 and the laser beam receiving module 20. The control circuit 30 includes a drive and conversion circuit 31, a memory 33, a processor 32, and a computer program stored in the memory 33 and capable of running on the processor 32. When the processor 32 executes the computer program, the drive and conversion circuit 31 correspondingly implements steps of the foregoing ranging adjustment method of a LiDAR device 1.

The laser beam receiving module includes receiving units arranged into an array.

In some embodiments, the laser beam emission module 10 includes a single emission unit or m1 (rows)×n1 (columns) emission units arranged into an array, and the laser beam receiving module 20 includes m2 (rows)×n2 (columns) receiving units arranged into an array, where m1 and n1 are both greater than or equal to 1, m2 and n2 are both greater than or equal to 1, m1 and m2 can be equal or unequal, and likewise, n1 and n2 can be equal or unequal. That is, in some embodiments, the number of rows and the number of columns of the emission array can be in a one-to-one correspondence with those of the receiving array. In some embodiments, the emission array and the receiving array can have unequal numbers of rows and equal numbers of columns. In some embodiments, the emission array and the receiving array can have equal numbers of rows and unequal numbers of columns. This application imposes no limitation on specific structures of the emission array and the receiving array.

It can be understood that this application also imposes no limitation on the scanning form of the LiDAR. The LiDAR can include scanning members such as a rotating mirror or a galvanometer, and the LiDAR can also be a mechanical rotary LiDAR, that is, a turntable drives the emission array and the receiving array to rotate and scan. In some embodiments, the LiDAR in this application may also be pure solid-state LiDAR. A specific type of LiDAR is not limited in this application.

The emission units and the receiving units may be disposed one-to-multiple or multiple-to-multiple, the laser beam emission module 10 also includes an emission lens disposed in an array structure, the emission lens includes one or more lenses, the laser beam receiving module 20 also includes a receiving lens disposed in the array structure, the receiving lens includes one or more lenses, and the laser beam emission module 10 is driven by the control circuit 30 to emit a laser beam of corresponding power and/or the number of laser beams to the to-be-detected object 2. The laser beam is reflected by the to-be-detected object 2 back to the laser beam receiving module 20, and the receiving unit receives the corresponding echo laser beam signal through the receiving lens, and the echo laser beam signal is converted into a corresponding echo pulse signal. The processor 32 determines the corresponding histogram data based on the echo pulse signal.

In addition, the processor 32 obtains the position information of the to-be-scanned receiving unit, and queries the table to obtain a matched attenuation coefficient. The attenuation coefficient refers to a ratio of the number of incident photons to the number of received photons. For example, when 100 photons are incident, the receiving unit receives 80 photons, and it indicates that the attenuation coefficient is 80%, that is, 0.8. When the attenuation coefficient is 1, it indicates that the number of photons incident on the receiving lens is equal to the number of received photons, and the number of photons is not attenuated, thereby obtaining the maximum attenuation coefficient. The attenuation coefficient is related to the position and a material of the receiving lens. An attenuation coefficient of each receiving unit can be calculated and calibrated theoretically based on a position relationship and an angle, or can be calibrated based on actual optical detection, that is, the attenuation coefficient of each receiving unit is calculated theoretically based on a divergence angle of an outgoing light spot of the corresponding emission unit and/or is calibrated and determined via optical detection. After the attenuation coefficient of each receiving unit is determined, the attenuation coefficient and the position relationship of each receiving unit form mapping and are stored in the memory 33 to form the attenuation coefficient table.

In addition, in order to improve the ranging accuracy and the ranging capability and reduce design costs and simplify a structure of the emission unit, the processor 32 controls the drive and conversion circuit 31 to increase the number of laser beam emissions and/or the emission power, to increase the accuracy of ranging. In addition, in order to match the attenuation coefficients with different receiving units, the number of laser beam emissions and/or the emission power is determined in a corresponding calculation method. Herein, the attenuation coefficient is negatively correlated with the number of laser beam emissions, that is, the larger the attenuation coefficient of the receiving unit, the smaller the number of required laser beam emissions; or the smaller the attenuation coefficient of the receiving unit, the larger the number of required laser beam emissions.

In addition, the attenuation coefficient is negatively correlated with the emission power, that is, the larger the attenuation coefficient of the receiving unit, the smaller the emission power required for the corresponding emission unit; or the smaller the attenuation coefficient of the receiving unit, the larger the emission power required for the corresponding emission unit.

When the emission unit and the receiving unit are disposed one-to-one to perform emission and reception, the attenuation coefficient of the receiving unit to perform scanning is used to calculate the attenuation coefficient corresponding to the number of laser beam emissions and/or the emission power, and the attenuation coefficient of the receiving unit is used to determine the number of laser beam emissions and/or the emission power. The processor 32 performs corresponding histogram data superimposition on the echo laser beam signal based on the corresponding number of echo superimpositions, thereby forming the histogram data. In addition, the histogram data are used to determine the distance information of the to-be-detected object 2, where the number of laser beam emissions is greater than or equal to the number of echo superimpositions.

In addition, when the emission units and the receiving units are disposed one-to-multiple or multiple-to-multiple to perform emission and reception, in order to improve the overall uniformity of ranging and ensure that multiple receiving units all can receive echo laser beam signals corresponding to the number of emissions and/or the emission power, position information of multiple receiving units corresponding to the emission unit to perform scanning is obtained, and the table is queried to obtain the attenuation coefficients matching the multiple receiving units. In addition, the number of laser beam emissions of the corresponding emission unit is determined via the minimum attenuation coefficient, to ensure that the multiple receiving units corresponding to the emission unit can receive multiple echo laser beam signals corresponding to a laser beam emitted by the emission unit. For example, attenuation coefficients of four receiving units corresponding to the emission unit to perform scanning are 0.6, 0.6, 0.4, and 0.2, separately. The attenuation coefficient of 0.2 is used as a target attenuation coefficient, and the laser beam emission power and/or the emission power is calculated via the target attenuation coefficient to determine the laser beam emission power and/or the emission power.

In addition, based on the respective attenuation coefficients of the receiving units, respective corresponding numbers of echo superimpositions are determined. After the number of laser beam emissions and the corresponding echo superimpositions of the to-be-scanned emission unit are determined, the processor 32 controls the drive and conversion circuit 31 to drive the corresponding to-be-scanned emission unit and at least one receiving unit to perform continuous laser beam emission and reception work multiple times. In addition, the processor 32 forms the histogram data based on multiple echo pulse signals in a changing time sequence that are converted by the receiving unit, determines a time difference between laser beam emission and reception via any calculation policy of constant-ratio timing calculation, peak value calculation and half-value calculation, and determines the distance information of the to-be-detected object 2 based on the time difference and a speed of light.

The emission unit includes a laser such as a gas laser, a solid-state laser, or a semiconductor laser. The laser emits a laser beam under action of the drive and conversion circuit 31. The laser beam emission module 10 also includes an emission lens disposed corresponding to the laser. The emission lens is disposed relative to one or more lasers. In addition, the receiving unit includes a photoelectric converter, the laser beam receiving module 20 also includes at least one receiving lens disposed corresponding to multiple photoelectric converters, and the photoelectric converter converts the reflected echo laser beam signal into an echo pulse signal of a corresponding electrical signal type, and the echo pulse signal is converted and output to the processor 32 through the drive and conversion circuit 31 to determine the histogram data and determine the distance information of the to-be-detected object 2. Herein, the receiving lens is disposed relative to one or more photoelectric converters.

The photoelectric converter can use a corresponding photoelectric structure. In some embodiments, the photoelectric converter includes a photoelectric conversion diode, and the photoelectric conversion diode completes photoelectric conversion. Any one of a silicon photodiode, Avalanche Photo Diode, PIN photodiode, Schottky barrier photodiode, HgCdTe photovoltaic diode, or the like can be selected as the photoelectric conversion diode. In some embodiments, the photoelectric conversion diode is selected based on a requirement of the LiDAR device 1. In some embodiments, the photoelectric conversion diode is Single Photon Avalanche Diode (SPAD).

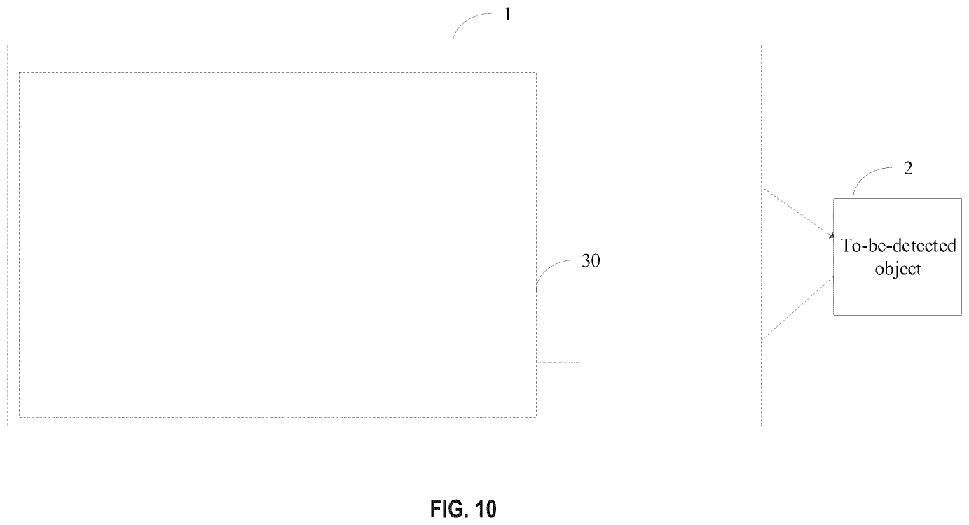

The drive and conversion circuit 31 completes drive work of the emission unit and signal conversion work of the receiving unit, and can use a corresponding laser beam drive circuit 311 and a signal processing circuit, for example, a charging and discharging circuit, an amplifier, and other structures. As shown in FIG. 10, in some embodiments, the drive and conversion circuit 31 includes: a laser beam drive circuit 311 respectively connected to the processor 32 and the laser beam emission module 10, where the laser beam drive circuit 311 is correspondingly turned on or off based on a control signal output by the processor 32, and adjusts the number of laser beam emissions and/or emission power of the emission unit in a frame of a scanning image; and a signal conversion circuit 312 respectively connected to the laser beam receiving module 20 and the processor 32, where the signal conversion circuit 312 is configured to: convert a current signal converted and output by the receiving unit into a corresponding echo pulse signal, and output the echo pulse signal to the processor 32.

The laser beam drive circuit 311 is driven by a drive control signal output by the processor 32 to drive the laser to work, and the laser emits a laser beam based on the preset power and the corresponding number of emissions, so that the receiving unit receives multiple corresponding echo laser beam signals. In addition, when an echo laser beam signal is received, the photoelectric converter and the signal conversion circuit 312 sequentially convert an optical signal into a current signal and convert the current signal into a voltage signal, and output multiple echo pulse signals to the processor 32, and the processor 32 determines the corresponding histogram data and the distance information of the to-be-detected object 2.

The laser beam drive circuit 311 can use a corresponding charging and discharging circuit, and the charging and discharging circuit is connected to the laser correspondingly to implement charging and discharging drive work multiple times. The signal conversion circuit 312 can use a transconductance amplifier, a detection circuit, and the like to complete conversion of the electrical signal, detect and collect the echo signal, and perform conversion and output multiple echo pulse signals to the processor 32. The processor 32 obtains corresponding histogram data based on the multiple echo pulse signals, and then achieves a purpose of ranging the to-be-detected object 2.

The foregoing embodiments are merely intended to describe the technical solutions of the present disclosure, but not to limit the present disclosure.

What is claimed is:

1. A ranging adjustment method of a LiDAR device, wherein the LiDAR device comprises a laser beam emission module and a laser beam receiving module, and the laser beam receiving module comprises receiving units arranged into an array; and
wherein the ranging adjustment method comprises:
obtaining position information of a receiving unit corresponding to a to-be-scanned emission unit, and querying a table to obtain an attenuation coefficient matching the receiving unit;
calculating a number of continuous laser beam emissions or an emission power of the emission unit corresponding to the receiving unit in a frame of a scanning image based on the attenuation coefficient;
driving the emission unit to emit a laser beam based on the number of emissions or the emission power, simultaneously driving the receiving unit corresponding to the emission unit to receive a corresponding echo laser beam signal, and superimposing the echo laser beam signal into corresponding histogram data; and
determining distance information of a to-be-detected object based on the histogram data.

2. The ranging adjustment method according to claim 1, wherein before obtaining the position information of the receiving unit corresponding to the to-be-scanned emission unit, and querying the table to obtain the attenuation coefficient matching the receiving unit, the ranging adjustment method further comprises:
obtaining a correspondence between the to-be-scanned emission unit and the receiving unit; and
querying the table based on the correspondence, to obtain the attenuation coefficient matching the receiving unit, wherein when the correspondence between the to-be-scanned emission unit and the receiving unit is a one-to-one correspondence, the attenuation coefficient of the receiving unit is an attenuation coefficient of the receiving unit corresponding to the to-be-scanned emission unit.

3. The ranging adjustment method according to claim 1, wherein before obtaining the position information of the receiving unit corresponding to the to-be-scanned emission unit, and querying the table to obtain the attenuation coefficient matching the receiving unit, the ranging adjustment method further comprises:
obtaining a correspondence between the to-be-scanned emission unit and the receiving unit; and
querying the table based on the correspondence, to obtain the attenuation coefficient matching the receiving unit, wherein when the correspondence between the to-be-scanned emission unit and the receiving unit is a one-to-multiple or multiple-to-multiple correspondence, the attenuation coefficient of the receiving unit is a minimum attenuation coefficient of multiple receiving units corresponding to the to-be-scanned emission unit.

4. The ranging adjustment method according to claim 1, wherein a calculation formula of the number of superimpositions of the histogram data corresponding to the receiving unit is as follows:
$$num 2 = {( \frac{coe 1}{coe 2} )}^{2} * num 1 ;$$
wherein coe1 is an attenuation coefficient of a reference receiving unit, coe2 is an attenuation coefficient of the receiving unit corresponding to the to-be-scanned emission unit, num1 is the number of superimpositions of histogram data corresponding to the reference receiving unit, and num2 is the number of superimpositions of histogram data corresponding to the receiving unit corresponding to the to-be-scanned emission unit.

5. The ranging adjustment method according to claim 4, wherein driving the corresponding receiving unit to receive the corresponding echo laser beam signal, and superimposing the echo laser beam signal into the corresponding histogram data comprise:
obtaining an attenuation coefficient of the receiving unit corresponding to the emission unit;
calculating the number of echo superimpositions of the receiving unit based on the attenuation coefficient of the receiving unit; and
performing corresponding histogram data superimposition on the echo laser beam signal based on the number of echo superimpositions to form the corresponding histogram data.

6. The ranging adjustment method according to claim 1, wherein determining the distance information of the to-be-detected object based on the histogram data comprises:
performing one of constant-ratio timing calculation, peak value calculation, or half-value calculation on the histogram data to determine a time difference between laser beam emission and reception; and
determining the distance information of the to-be-detected object based on the time difference.

7. The ranging adjustment method according to claim 1, further comprising:
obtaining a peak value of the histogram data;
determining whether the peak value of the histogram data is less than a preset threshold; and
when the peak value of the histogram data is less than the preset threshold, adjusting the number of emissions or emission power for a next emission.

8. A LiDAR device, comprising:
a laser beam emission module;
a laser beam receiving module, comprising receiving units arranged into an array; and a control circuit respectively connected to the laser beam emission module and the laser beam receiving module, wherein the control circuit comprises a drive and conversion circuit, a memory, a processor, and a computer program stored in the memory and capable of running on the processor, wherein when executing the computer program, the processor correspondingly drives the drive and conversion circuit to implement operations comprising:
obtaining position information of a receiving unit corresponding to a to-be-scanned emission unit, and querying a table to obtain an attenuation coefficient matching the receiving unit;
calculating a number of continuous laser beam emissions or an emission power of the emission unit corresponding to the receiving unit in a frame of a scanning image based on the attenuation coefficient;
driving the emission unit to emit a laser beam based on the number of emissions or the emission power, simultaneously driving the receiving unit corresponding to the emission unit to receive a corresponding echo laser beam signal, and superimposing the echo laser beam signal into corresponding histogram data; and
determining distance information of a to-be-detected object based on the histogram data.

9. The LiDAR device according to claim 8, wherein
the emission unit comprises a laser;
the laser beam emission module comprises an emission lens disposed corresponding to the laser;
the receiving unit comprises a photoelectric converter; and
the laser beam receiving module further comprises at least one receiving lens disposed corresponding to photoelectric converters arranged into an array.

10. The LiDAR device according to claim 8, wherein the drive and conversion circuit comprises:
a laser beam drive circuit respectively connected to the processor and the laser beam emission module, wherein the laser beam drive circuit is correspondingly turned on or off based on a control signal output by the processor, and adjusts the number of laser beam emissions or emission power of the emission unit in a frame of a scanning image; and
a signal conversion circuit respectively connected to the laser beam receiving module and the processor, wherein the signal conversion circuit is configured to: convert a current signal converted and output by the receiving unit into a corresponding echo pulse signal, and output the echo pulse signal to the processor.

11. The LiDAR device according to claim 9, wherein the photoelectric converter comprises a photoelectric conversion diode.
